(19) United States
(12) Patent Application Publication
(10) Pub. No.: US 2015/0371161 A1
(43) Pub. Date: Dec. 24, 2015

(54) SYSTEM AND METHODS FOR IDENTIFYING, EVALUATING AND PREDICTING LAND USE AND AGRICULTURAL PRODUCTION

(71) Applicant: The Board of Trustees of the University of Illinois, Urbana, IL (US)

(72) Inventors: Steffen MUELLER, Chicago, IL (US); Kenneth COPENHAVER, Urbana, IL (US)

(21) Appl. No.: 14/764,597

(22) PCT Filed: Jan. 30, 2014
(86) PCT No.: PCT/US2014/013779

§ 371 Date: Jul. 30, 2015

Related U.S. Application Data
(60) Provisional application No. 61/758,575, filed on Jan. 30, 2013.

(51) Int. Cl. G06Q 10/06; G06Q 30/00; G06Q 50/02; A01B 79/00

(52) U.S. Cl. CPC G06Q 10/0631; A01B 79/005; G06Q 30/018; G06Q 50/02

(57) ABSTRACT

A system and methods for analyzing land use and productivity. The invention relates to land use analysis through detection, monitoring and evaluating changes in particular land regions of interest and the analysis of changes in such land use as well as the forecasting of in-season productivity of vegetation in the region of interest. This system and methods is applicable to facilitate the automatic preparation of reports for a selected parcel of land that evaluates changes in land use and creates a quantitative report for one or more land regions of interest. This system and methods is useful to assess compliance with government regulations or standards regarding land use as well as provide a predictive land use productivity model used for commodity trading.

### CROSS-REFERENCE TO RELATED APPLICATIONS

This application claims the benefit of U.S. Provisional Application No. 61/758,575, filed Jan. 30, 2013 entitled “System and Methods for Evaluating and Presenting Land Use”, the disclosure of which is incorporated by reference.

### FIELD OF THE INVENTION

The present invention relates generally to a system and methods for analyzing land use. In particular, the present invention permits one or more land uses to be identified, one or more sections of land to be selected, historical information gathered for the selected land section or sections, changes in the use of the land sections detected, information regarding the change in land and/or the current use and in-season agricultural feedstock productivity of the land relative to the historical use be made available, and prediction of future use and feedstock productivity of the land relative to the historical and present use. Advantageously, through the use of the present invention, reports in the form of maps, tabular data or a matrix for a selected parcel of land may be prepared that indicate the changes in land use and past, current and future feedstock productivity. The present invention also allows for written, geospatial or graphical data analysis. The analysis may be used to assess compliance with the government regulations or standards and guide land use decisions including to make informed business and financial transactions.

### BACKGROUND

There has always been an interest in determining how land has been used in the past, is being used in the present, how productively it has and is being used in the present for agricultural feedstock production, and better predict how it may be used in the future. Recent emphasis on the production of biofuels, feed, and food has given rise to concerns that the increased demand for agricultural feedstock may drive the conversion of native ecosystems to agriculture, that is, from grassland or forest to corn or soybeans. Such a conversion may portend an increase in greenhouse gas (“GHG”) emissions from release of soil carbon and removal of carbon capturing vegetation. Biofuels are a form of renewable energy and can reduce petroleum use and carbon emissions. Ethanol is an example of such renewable energy and is easily produced from agricultural feedstock or vegetation that contains large amounts of sugar or components that can be converted into sugar, such as starch or cellulose. Similarly, biodiesel produced from agricultural soybean feedstock, or other vegetable oils constitutes another example of renewable energy in the form of biofuels. Many producers of food, feed, and biofuels undergo sustainability certification of the land used to make their product. Certifying the sustainability of the land in which the raw material is grown for food, feed and biofuels production is critical towards the sale of the product in certain domestic markets along with exportation of the product. Certification is provided by many entities that adopt protocols and standards such as, for example, those set by the International Sustainability & Carbon Certification (ISCC) for food, feed and biofuel certification system. While many certification schemes for food, feed and biofuels are voluntary, a regulatory certification mandate exists, for example, for biofuels sold in the European Union (EU) for recognition under the Renewable Energy Directive (EU RED). The directive requires all EU member countries to increase the amount of renewable energy they use to twenty percent by 2020. Additionally, ten percent of the member countries' transportation fuel must be derived from sustainable biofuels by 2020. To qualify as sustainable in the European Union, the biofuel must be certified to ensure that it is not derived from lands converted from rainforests or grasslands, that the entire production process is deemed sustainable, and that the biofuels reduce greenhouse gas emissions by thirty-five percent compared to petroleum. Multiple U.S. organizations have obtained ISCC certification for products exported to the EU and many are working on the development of similar certification programs. Both the organization looking for sustainability certification and maintaining their certification as well as the organization providing the certification require a method in which to analyze and report on the land use sustainability.

Although the ISCC certification is the most well-known international certification scheme and has been the scheme of choice to date in North America for biofuels export certification to Europe, other approved schemes have begun to emerge and implementation standards for similar renewable systems, such as feedstock or industry in specific geographical regions. Through utilization of similar baseline requirements for certification in the United States and Europe, importing and exporting of raw materials converted into food, feed, and renewable energy biofuels as a commodity are available. The importing and exporting of goods impacts the financial marketplace with regard to trading of commodities. To analyze and forecast the value of commodities, such as corn, the understanding of the use and productivity of land used to grow the agricultural feedstock is necessary.

Information and data that may help in land use assessment has been collected through the use of various techniques over the years. For example, since the 1970s when the first Landsat satellites were put into geostationary orbit, “remotely sensed imagery” and remote sensing datasets have been made available to assist in land use assessment. NASA satellite imagery, for example, can be used to predict soil moisture, vegetation vigor, feedstock type, feedstock phenology, and feedstock daytime and night time temperature. The USGS Landsat 8 satellite can be used to perform the above functions, but with higher resolution, can also see stress and variability within an agricultural field.

Using NASA and USGS satellite imagery along weather data, any party interested in local feedstock progress can focus to an area of interest and receive information about a number of different conditions related to land use and productivity. These conditions can then be quantified to gain insight into the use of the land for given time periods and may assist in formulating a predictive model of future use of the land. Such conditions, for example, include: the accumulated growing degree days throughout the season compared to previous years; the night time minimum temperature for the critical mid-July through mid-August period compared to previous years; the precipitation compared to previous years; the vegetative vigor compared to previous years; predicted acres for a selected vegetation species or group; the leaf area index and fraction of photosynthetic activity which are important indicators of plant health, and the vegetative yield prediction for a chosen area.

The accumulated growing degree days throughout the season compared to previous years is based on growing degree days (GDD). GDD is a measure of accumulated heat throughout the growing season, which is one of the key metrics influencing the phonological development and yield of feedstock. GDD are calculated by determining the mean daily temperature and subtracting it from the base temperature needed for growth of the organism.

The night time minimum temperature for the critical mid-July through mid-August period compared to previous years assists in defining yield production. In example, high night time temperatures from July 15 to August 15 have been found to affect yield. In a study by Elwynn Taylor of Iowa State University, hybrid maize yields across the state from 2009 (minimum night time temperature 58 degrees F.) and 2010 (minimum night time temperature 66 degrees F.) were compared. The increase in high night time temperature from 2009 to 2010 was reported to reduce yield from 2009 to 2010 by 5-13 percent.

Total ground water and water precipitation is another factor influencing yield because water abundance or scarcity is critical in vegetative growth. Data is available at daily increments with a fiscal cycle starting on October 1st each year. In example, the average corn water use will increase from about 0.03 inches per day after emergence to over 0.27 inches per day during ear formation.

Vegetative vigor compared to previous years provides quantitative information about the plant growth of a particular region of land using the normalized difference vegetation index (NDVI). This metric allows the user to benchmark the intensity/volume of vegetation on the fields at any point during the current growing season to the same time in earlier years.

Acreage prediction maps are based on proprietary routines to access, quality control, and process in-season datasets for benchmarking against a historic database that provides data at yearly intervals. Night time surface temperature from satellite combined with vegetation vigor from satellite and precipitation for the month of May when sorted by agricultural districts can be used to successfully predict planted acres for corn.

Yield prediction is based on proprietary routines to access, quality-control, and process in-season vegetation vigor, night time surface temperature, leaf area index and fraction of photosynthetic activity from satellite, along with precipitation, growing degree days and soil moisture, for benchmarking against a historic data base.

However, there are a variety of problems with such information and data that reduces its usefulness. For example, the information and data may include classification errors such as whether the data is for a forested area or an area of feedstock land or whether the changes that may have taken place are not because of the conversion of native ecosystems to agriculture but simply changes in existing areas of land that act as buffers or transitional components (areas currently not in feedstock but recently in feedstock or under-utilized areas). The data may include information that is irrelevant to land use issues, thereby preventing the information and data to be used efficiently in land use decisions. The information and data also may be produced in intervals that are too widely spaced in time for meaningful conclusions to be drawn (low temporal resolution). The information and data may reside in such disparate sources that it is difficult for it to be organized to allow timely decisions to be made.

A demand therefore exists for a system and methods by which historical and contemporary land use and productivity can be more accurately and efficiently assessed and more accurate predictions of future land use produced. The present invention satisfies this demand.

### SUMMARY OF THE INVENTION

The present invention is a system and methods by which data may be located, identified, collected, organized, quantified and presented from one or more sources for one or more identified parcels of land. For purposes of this application, “data” is information which may be transformed from raw information that is collected into computational and quantified information. Sources of raw information include, but are not limited to, geospatial weather data, earth imaging satellite imagery, aerial photography, aerial mapping, planar photography (Google Streetview or other views generated from car, truck, van, train, helicopter, airplane, or boat etc), tabular data, etc. Sources also include land use classification maps such as the USDA Cropland Data Layer. USDA Cropland Data Layer, for example, defines land use for a minimum of 30 meter square or 56 meter square parcels of land. Certain visual data may be organized into what will be termed, for purposes of this application, as a “data layer”. Data from a table or similar row and column apparatus can be organized into what will be termed, for purposes of this application, as a “dataset”. One or more data layers and/or one or more datasets can be transformed from its raw information into quantified information to evaluate an identified parcel of land, which will be termed, for purposes of this application, “land use data”.

One embodiment of the present invention utilizes what is known as a geospatial data layer server with an extensive library of, vetted land change layers, USDA Farm Services Agency National Agriculture Imagery Program (NAIP) aerial photography, roadways, biorefinery location data layers, weather, satellite imagery and vegetation productivity and health information products derived from satellite imagery and for selected areas, land ownership information. This embodiment facilitates access to data concerning historical, present and predicted future land use and productivity by which a user may track and display current and historical land use and productivity of agricultural fields and other land parcels. The land use history for the parcel may include transitions from pasture/forest land to feedstock land, reversions from feedstock to pasture/forest land, as well as feedstock rotations.

In one embodiment, the present invention permits the classification of land use data obtained from one or more data layers to define land use over a given period of time for a defined parcel of land. This is accomplished by recoding the data into similar classifications obtained from various vetted data layers for the given time periods.

Another embodiment of the present invention provides a method of improving accuracy of measuring changes in land use, plant growth, or vigor through the use of satellite images. The method involves an automated method for inspecting the satellite images, for example, those obtained twice daily by NASA MODIS, for cloud free areas. The NDVI is calculated for cloud free pixels and associated with the accumulated degree days (ADD). These values can be used to predict in-season crop growth or vigor by comparing to crop growth or vigor from previous years.

Another embodiment of the present invention permits the evaluation of datasets that defines changes in land use and productivity over time. Such time periods vary based on user specification input and can range from long (multi-year) to short (in-season) timeframes. While datasets obtained at different times separated by one or more growing seasons provide land use information, data collected at shorter time periods, such as days, may be suitable for forecasting end-of-season feedstock yield.

An additional embodiment of the present invention provides evaluation of in-season land use and feedstock conditions with historical benchmarking. Such feedstock conditions include, but are not limited to, the growth of the plant based on its age after planting, the health of the feedstock, possible nutrient deficiencies of the feedstock and the potential yield of the feedstock. Potential data layers used for the evaluation may include the amount of rainfall year to date, the growing degree days for the land in the region of interest, the vigor of the feedstock measured by satellite or airborne imagery. The embodiment makes possible rapid processing of new in-season satellite imagery collected repeatedly and weather station data and allows the new data to be compared in a geospatial format with databases of vegetation, climate, and planting history from previous years.

Another embodiment of the present invention permits the evaluation of different datasets over different ranges of time. For example, two different land regions of interest may be compared at the same time interval. Another example is the comparison of two different land regions of interest at two different time intervals.

An additional embodiment of the invention is the analysis of defined variation in land use from datasets to predict future land use and productivity. Utilization of datasets obtained at two or more discrete times and comparing the land use by overlaying the two or more datasets produces predicted changes in land use. A user interested in a specific land parcel can focus to an area of interest, click on the center point or delineate a boundary, e.g., a field or parcel, and receive the land use changes and utilize such information to forecast future land use. The forecast of future land use includes a relative risk assessment for that parcel's likelihood of land use change in the future (for example from forest to agricultural land).

Some added embodiments pertain to the data quality and permit the accuracy of assessed historic land use change to be enhanced following a comparison of datasets from two or more different time periods by further assessing whether an area of predicted land use change has an unlikely land use change. For example, to identify whether the use of a selected area has changed from agriculture to forest or from forest to agriculture, additional historical datasets obtained may be utilized to determine the accuracy of such land use change. In such example, if land use fluctuated from forest to agriculture and back to forest during a period of only a few years, it is an unlikely land use change and such data point in the dataset can be removed from the output data.

In some embodiments, the accuracy of the land use data may be further improved by allowing one or more data layers to be analyzed in conjunction with road maps and subtracting identified road buffers from the quantified land use data from the one or more data layers. Road buffers may be subtracted from a data layer for a given time prior to comparison with a second data layer, or road buffers may be subtracted from an overlay of two or more data layers.

Additional embodiments permit the juxtaposition of data layers regarding transition areas between two different types of land use which are often erroneously identified and classified in data layers.

Another embodiment utilizes a unique routine program update from ERDAS Imagine to remove roadways and unlikely land use rotations based on a set of decision parameters from a land use classification layer such as the US Department of Agriculture Cropland Data Layer to increase accuracy of the land use change detection. A change matrix based on the vetted land use layer is created and overlaid over the NAIP photographs for each year of predicted change.

Another embodiment utilizes methods to statistically aggregate identified land use change parcels and project the risk for future land use change on a regional level.

Certain embodiments of the present invention may include additional systems and methods by which a user may access and interact with the datasets. Further embodiments allow a user to select a parcel of land, review land use and changes of land use, and refine data for the selected parcel of land. Additionally, these certain embodiments of the present invention may allow a user to produce a report with representations of the data for the selected parcel of land so that, at least, non-directly verified conclusions may be reached regarding land use for the specific land parcel selected.

Also provided are methods of predicting agricultural feedstock production and growth involving the comparison of NDVI of a feedstock of interest and the accumulated degree days (ADD) in which the feedstock was grown to those of NDVI and ADD from one or more previous growing seasons. Information about feedstock growth from the previous growing season(s) is used to predict in-season feedstock growth for the feedstock of interest.

An additional embodiment of the present invention may facilitate the verification of the data received and tentative conclusions reached. Verification is the process of obtaining additional information to support (or refute if appropriate) the findings of the land use assessments. Verification is performed through recorded evidence by a reputable source. Such reputable sources could include the use of a historical data source identifying land use such as a historic planar or aerial photograph demonstrating use of land or current source of data such as a field service agent who will input their geo- coordinates on a GPS-based locational recording system to the database and record evidence regarding use of land at a particular location and time point. The recorded evidence of land use, such as an aerial or planar photograph of the land, will then either positively verify or negatively refute the use of land claimed in the dataset at the global coordinate location at the time point the evidence was produced.

These and other features, aspects, and advantages of the present invention will become better understood with regard to the following description, appended claims, and accompanying drawings.

### DRAWINGS

FIG. 1 illustrates a flow chart of an embodiment of the invention by which data is prepared, processed and made available to a user in an interactive session.

FIG. 2 is a flow chart of an embodiment of data preparation according to the present invention.

FIG. 3 is a flow chart of an embodiment of an interactive session with a user according to the present invention.

FIG. 4 is a flow chart of an embodiment of reporting analysis according to the present invention.

FIG. 5 is a flow chart of an embodiment of field verification according to the present invention.

FIG. 6A shows screen shots of a cropland data layer.

FIG. 6B shows a cropland data layer over an aerial photo.

FIG. 6C shows land transitions and reversions.

FIG. 6D shows a plat map and cropland data over aerial photo.

FIG. 7 illustrates a cloud computing system that may be used to implement the systems and methods according to the present invention.

### DETAILED DESCRIPTION

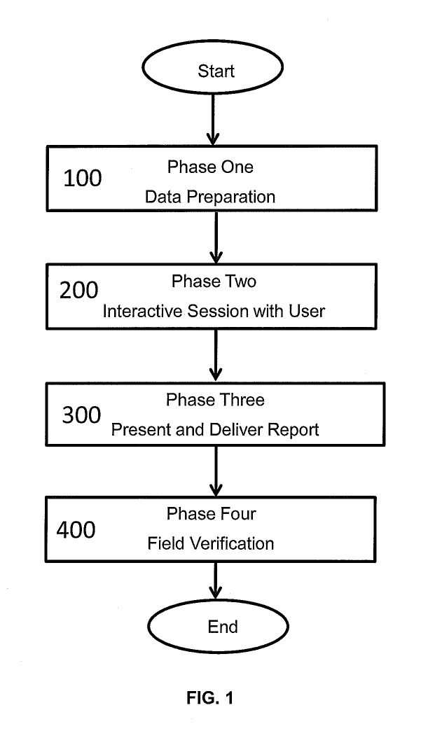

The present invention provides systems and methods by which land use, land productivity, and land use changes may be identified and quantified from one or more different data sources. One preferred embodiment of the present invention provides a system and method by which land use, land productivity and land use changes in different regions and/or historical time periods may be identified and quantified. Another embodiment of the present invention provides a system and methods by which land use, land productivity and land use changes may be modified to improve accuracy of reporting such occurrences. An added embodiment of the present invention provides a system and methods for predicting in-season feedstock productivity. In yet another aspect, the present invention provides a system and method for producing a user-friendly report and/or map of such quantified data. FIG. 1 illustrates a flow chart 100 of one of the preferred embodiments of the invention by which land use changes are analyzed.

The method according to the present invention involves multiple phases, as shown in FIG. 1. With reference to FIG. 1, data is obtained (Phase 1; 102) and made available to online users through an interactive session (Phase 2; 104). Results may be printed and/or delivered in a report (Phase 3; 106). Finally, the results are subjected to field verification (Phase 4; 108).

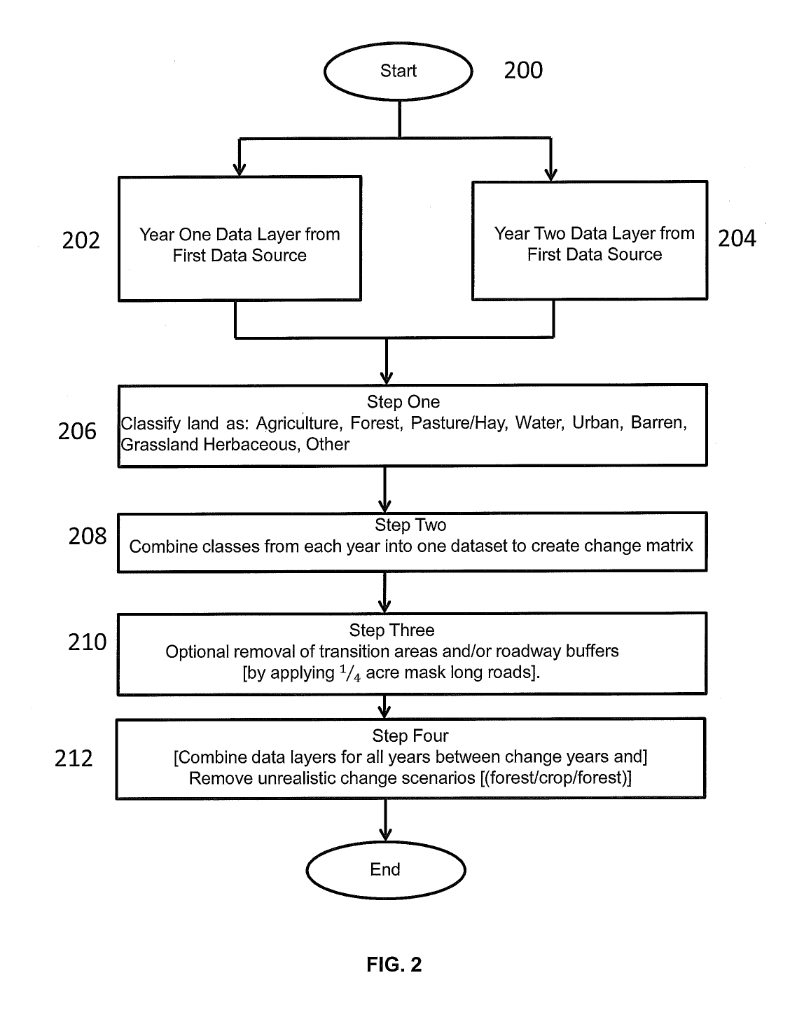

Following the steps of the flow chart 200 according to FIG. 2, in one embodiment, for a given parcel of land, data for a first data layer or dataset defining land use for year one 202 and data for a second data layer or dataset defining land use for year two 204 are provided. In certain embodiments, roadway buffers are removed according to Step Three 210. In certain embodiments, unlikely land use changes are removed according to Step Four 212.

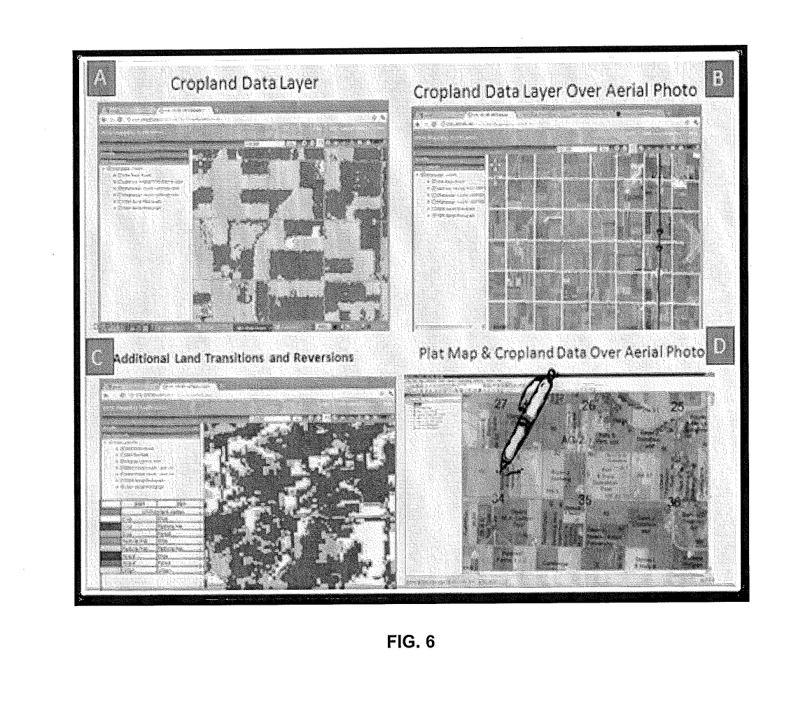

Land use for each data layer or dataset 202 and 204 is classified as agriculture, forest, pasture/hay, water, urban, barren, grassland, herbaceous, or other (Step One; 206). A screenshot of a data layer is shown in FIG. 6A. Data layers or dataset 202 and 204 are then analyzed by geospatially comparing the land use for a given land area from two time periods and determining whether this land use change would be of interest to the user (such as forest to agriculture) and if the land use change would be of interest providing information on the location and extent of change in map, tabular or matrix format to the user end (Step Two; 208; FIG. 6C). In map format, a specific color may denote a particular land use or land use change. In tabular format, more detailed information such as number of acres of change or the likely accuracy of the change can also be displayed. The matrix may display land use data across the top and the side of the chart and then give the number of acres or pixels that meet both land uses in each year such as forest at the top being 2007 and forest to the side being 2012, an acreage number in this matrix would indicate the number of acres that were potentially converted from forest to agriculture between these two years.

The resulting land use data may also be modified through removal of roadway buffers from the data layers or datasets and comparing the data again 210. For example, this may be accomplished using an algorithm that determines uses of land through comparison of two or more different source data layers or datasets, such as satellite images and aerial photography.

Land use changes identified in 208 can also be evaluated for the identification of unlikely land use changes. Unlikely land use changes include, for example, land that is classified as forest one year, agriculture the next, and subsequently returns to forest the following year. Such regions of land with identified unlikely land use changes may also be removed 212. These unlikely land use regions may be identified using an algorithm. Additional unlikely land use changes that are subtracted include land in transition areas, which may include some land that is in feedstock and other land that is in an alternative use, such as forest, grassland, water or roadway buffer etc. By comparing data layers or datasets from multiple years, e.g., intervening years between the years from which data layers or datasets 202 and 204 were obtained, additional transition areas can be identified and subtracted.

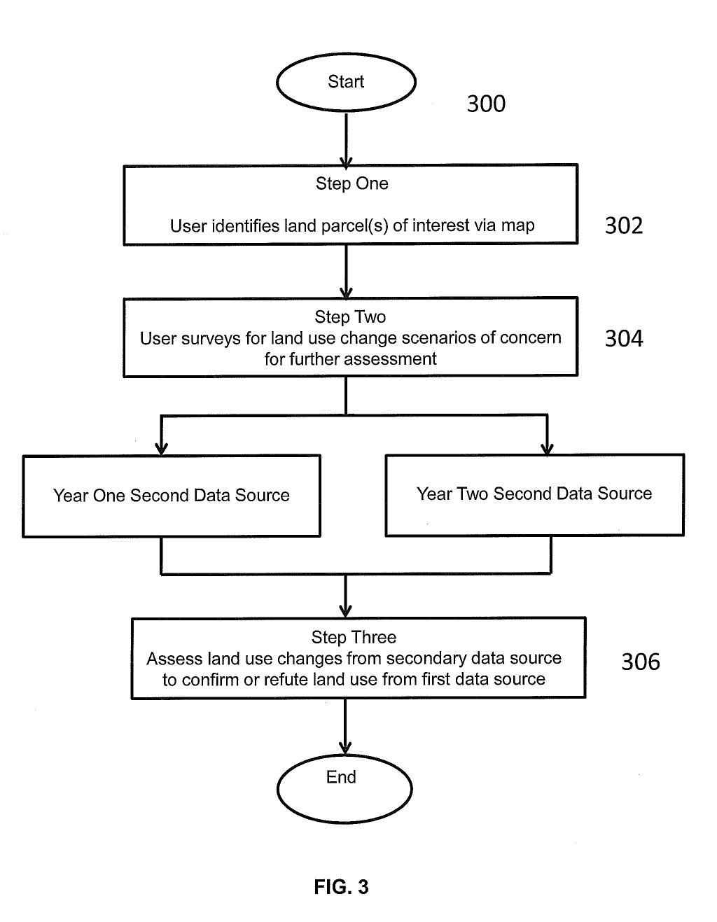

FIG. 3 illustrates an interactive session by a user. First, a user identifies a land parcel of interest using a map and one or more time points of interest (FIG. 3, 302). The system then prepares the land use data.in a matrix as described.

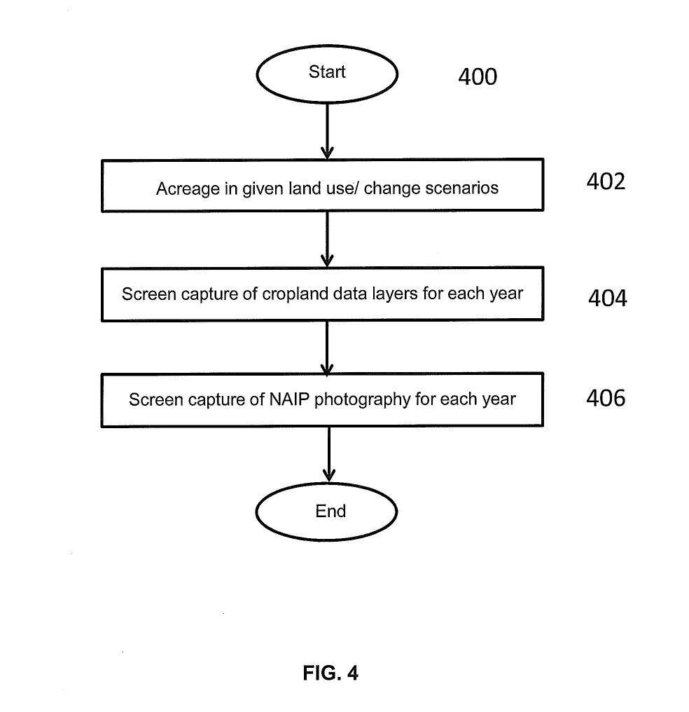

The method allows the user to review the matrix and determine whether there are land use changes of concern, such as unlikely land use changes, transition areas and/or roadway buffers that may require further assessment (304). If there are no areas of concern, the user may obtain a report which may be printed and/or delivered in an electronic format (FIG. 4; 400). The report may include the acreage for land use and land use changes 402. The report may also include a screen capture of land data layers for each year 404 and screen capture of aerial photography for each year 406 (FIG. 6B).

If the user identifies land use changes of concern 304, the user may access additional data source(s), such as aerial photographs for years one and two, to confirm or refute land use identified in the first data source to the secondary data source 306. If analysis of the second data source resolves user questions, the user may then print and/or deliver a report (FIG. 4).

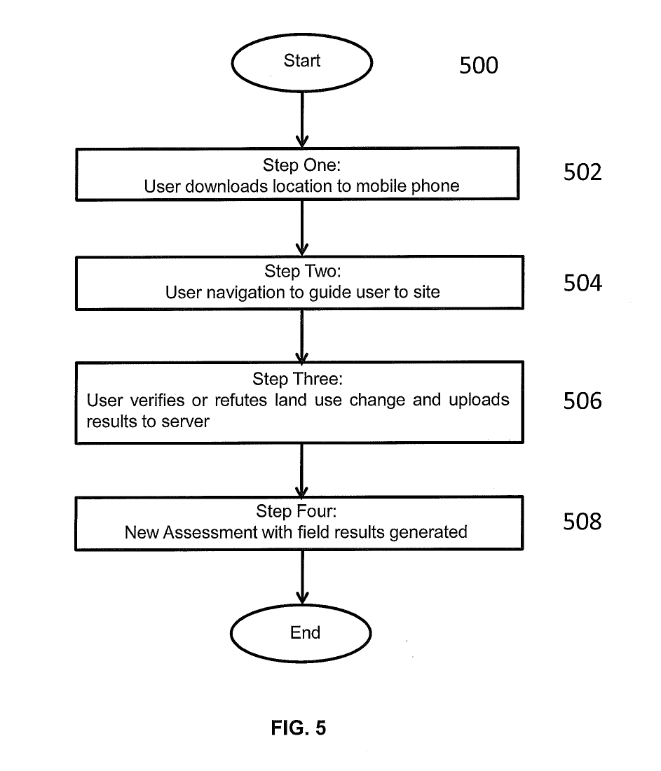

In order to assess a first or second data source 306, the user may also input data obtained through field verification (FIG. 5). In one embodiment, the user may perform field verification of land use changes by downloading the coordinates for the location to an application on a mobile phone that can use GPS to guide the user to a given location (502; FIG. 6D). The user may be guided to the actual location of potential land use change for physical verification using a map and GPS navigation (504). The user then verifies or refutes the land use change and uploads the results (506). Following uploading of the field verification results, a land use change assessment can be generated (508).

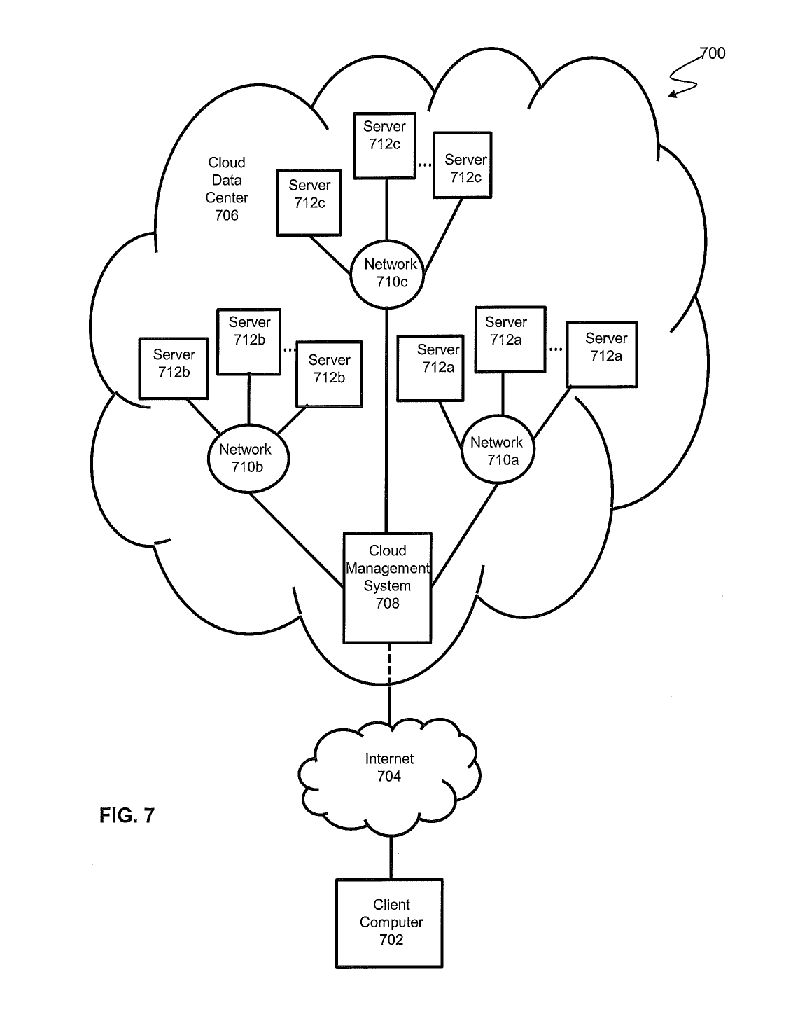

FIG. 7 illustrates an exemplary cloud computing system 700 that may be used to implement the methods according to the present invention. The cloud computing system 700 includes a plurality of interconnected computing environments. The cloud computing system 700 utilizes the resources from various networks as a collective virtual computer, where the services and applications can run independently from a particular computer or server configuration making hardware less important.

Specifically, the cloud computing system 700 includes at least one client computer 702. The client computer 702 may be any device through the use of which a distributed computing environment may be accessed to perform the methods disclosed herein, for example, a traditional computer, portable computer, mobile phone, personal digital assistant, or tablet to name a few. The client computer 702 includes memory such as random access memory (“RAM”), read-only memory (“ROM”), mass storage device, or any combination thereof. The memory functions as a computer usable storage medium, otherwise referred to as a computer readable storage medium, to store and/or access computer software and/or instructions.

The client computer 702 also includes a communications interface, for example, a modem, a network interface (such as an Ethernet card), a communications port, a PCMCIA slot and card, wired or wireless systems, etc. The communications interface allows communication through transferred signals between the client computer 702 and external devices including networks such as the Internet 704 and cloud data center 706. Communication may be implemented using wireless or wired capability such as cable, fiber optics, a phone line, a cellular phone link, radio waves or other communication channels.

The client computer 702 establishes communication with the Internet 704—specifically to one or more servers—to, in turn, establish communication with one or more cloud data centers 706. A cloud data center 706 includes one or more networks 710a, 710b, 710c managed through a cloud management system 708. Each network 710a, 710b, 710c includes resource servers 712a, 712b, 712c, respectively. Servers 712a, 712b, 712c permit access to a collection of computing resources and components that can be invoked to instantiate a virtual machine, process, or other resource for a limited or defined duration. For example, one group of resource servers can host and serve an operating system or components thereof to deliver and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software.

The cloud management system 708 can comprise a dedicated or centralized server and/or other software, hardware, and network tools to communicate with one or more networks 710a, 710b, 710c, such as the Internet or other public or private network, with all sets of resource servers 712a, 712b, 712c. The cloud management system 708 may be configured to query and identify the computing resources and components managed by the set of resource servers 712a, 712b, 712c needed and available for use in the cloud data center 706. Specifically, the cloud management system 708 may be configured to identify the hardware resources and components such as type and amount of processing power, type and amount of memory, type and amount of storage, type and amount of network bandwidth and the like, of the set of resource servers 712a, 712b, 712c needed and available for use in the cloud data center 706. Likewise, the cloud management system 708 can be configured to identify the software resources and components, such as type of Operating System (“OS”), application programs, and the like, of the set of resource servers 712a, 712b, 712c needed and available for use in the cloud data center 706.

The present invention is also directed to computer products, otherwise referred to as computer program products, to provide software to the cloud computing system 700. Computer products store software on any computer useable medium, known now or in the future. Such software, when executed, may implement the methods according to certain embodiments of the invention. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, Micro-Electro-Mechanical Systems (“MEMS”), nanotechnological storage device, etc.), and communication mediums (e.g., wired and wireless communications networks, local area networks, wide area networks, intranets, etc.). It is to be appreciated that the embodiments described herein may be implemented using software, hardware, firmware, or combinations thereof.

The cloud computing system 700 of FIG. 7 is provided only for purposes of illustration and does not limit the invention to this specific embodiment. It is appreciated that a person skilled in the relevant art knows how to program and implement the invention using any computer system or network architecture.

While we have discussed many embodiments, modifications and alternative forms, specific exemplary embodiments have been shown by way of example in the drawings and have herein been described in detail. It should be understood, however, that there is no intent to limit the disclosure to the particular embodiments disclosed; the intention is to cover all modifications, equivalents, and alternatives falling within the scope of the disclosure as defined by the appended claims.

### EXAMPLES

### Example 1

### Detecting Year to Year Land Use Change

The land use change detection for a given parcel of land is performed using data analysis between land use in 2007 and land use in 2010 using satellite-derived USDA prepared Cropland Data Layers, which can be used to predict land use for parcels of land with minimum areas of 56 meters² (AWiFS) or 30 meters² (Landsat). Datasets for the two years are overlaid and a simple comparison is performed to determine what the predicted land use was in 2007 and 2010. Particular land use changes of interest can be highlighted such as forest to agriculture or grassland to agriculture.

However, simply comparing cropland data layers from different time periods may not be sufficiently accurate for certain applications, due to the multiplicative nature of errors when combining the two datasets. Such errors are frequently defined in transition areas, areas where land use change is commonly predicted.

To compensate for these errors and improve the accuracy of land use change detection, algorithms programmed in image processing software were developed to overlay roadway layers over feedstock land data layers and remove buffers along the roadways from the cropland data layers. These are often the areas with the largest error since many pixels have mixed land uses in their area.

Land use changes that are unlikely to occur over time, e.g., land use changes from agriculture to forest to agriculture, or forest to agriculture to forest, are detected and removed. Where unlikely land use changes are suspected and/or confirmed, a second algorithm may be used to remove unlikely land use changes. These areas are also typically pixels in transition areas in which some land is in feedstock and other land is in forest. Accuracy in distinguishing areas in transition versus change areas may be improved by including datasets from additional time points. For example, by combining the cropland data layers from 2008 and 2009, as well as 2007 and 2010, land use changes such as those described above can be identified as transition areas not change areas.

Once the cropland data layers have been compared, and roadway buffers and unlikely land use changes removed, the remaining land use change areas of concern are highlighted with distinctive colors visually using image processing or Geographic Information System software (for instance, forest converted to agriculture can be highlighted in red while all other transitions are left clear so the user can easily find and zoom in to areas where it is predicted forest has been converted to agriculture).

A final analysis process involves the use of USDA NAIP (National Agriculture Imagery Program) photographs, which are visually placed in a graphical user interface on a computer for each year behind the predicted change locations. The user can then clear the other layers and screen capture just the aerial photographs for the year before the change and the year of predicted change. These photographs are high resolution (two meter minimum mapping unit) airborne photographs collected by USDA to determine grower compliance to USDA regulations and are collected at the optimum time of the agricultural growing season to predict land use.

If land use change may be predicted by the cropland data layer comparison, the aerial photographs are used to confirm or refute the land use change. Finally, the user may select an area of interest, e.g., by drawing a polygon around the area of interest, and all of the land use change is documented with a screen capture of the satellite data predicted land use, the aerial photographs, and tabular calculations of acres for each land use change class. This report can then be emailed to anyone interested in the land use history of a given area of interest. The core of the vetting methods and accuracy statistics of detecting land use change are known.

### Example 2

### In Season Vegetation Vigor Prediction Model and Comparisons to Past Years

The NASA MODIS sensors collect 250 meter imagery in the red and near-infrared portions of the spectrum twice daily for the entire earth's surface (one sensor is on-board the Terra and one on-board the Aqua NASA satellites). The NASA-derived MODIS Satellite NDVI product (which shows vegetation vigor) is made available to the public approximately every 16 days year round, which is often a low temporal resolution for measuring vegetation change associated with feedstock development and yield. NASA chose time points in which most of the Earth's surface is cloud free in order to create a global cloud free image. The product is usually released several days after the imagery has been collected also further reducing its timeliness and usefulness.

Certain embodiments of the present invention utilize an algorithm that evaluates NASA's twice daily satellite images for the entire globe and determines if an area is cloud free. Only cloud free pixels over land areas of interest have an NDVI calculated. The values may be normalized to accumulated degree days (ADD), which is a closely watched measure of total cumulative heat throughout a growing season. Each ADD value is associated with maximum and minimum temperatures which can start at zero (when maximum temperature is below 50) and ending in the thousands. The ADD based on interpolated weather station data is derived and associated it with each pixel that is cloud free. Each day ADD increases by a value based on the min temperature (50 or above) and maximum temperature (86 or below as a cut-off) for corn. If a pixel value is zero (indicating cloud cover) it is the average of the days to each side of it which are cloud free is desired. For each day, rather than have daily NDVI values, a value for NDVI based on the ADD is obtained. At each given pixel, a temporal curve for days that do not equal 0 (cloud cover) was built. Then a temporal curve for ADD is established, the curves merge so one estimated value at any given NDVI equals an estimated value for an ADD. This is done for every 100 ADDs to avoid extremely large data files. These have been developed for previous years dating back to 2004.

Because corn phenology is tied to ADD, the NDVI value for this year at a given ADD can be compared to the NDVI value during previous years for the same ADD. Calibrating NDVI to weather station provided ADD data as opposed to calendar day gives a more accurate measurement of the condition of the corn at a particular growth stage and allows for comparisons to previous years to determine if vigor is better or worse. Changes in vigor may be tied more specifically to weather events which will affect corn productivity. This is an improvement over the much simpler vegetation vigor displays which solely uses satellite imagery.

### Example 3

### In Season Corn Acreage and Yield Prediction Model

MODIS NDVI data is used to predict locations planted in corn and then further predict the productivity measured in yield for these locations. Corn, compared to almost any other land cover, has a distinctive temporal growth curve. Land appears as bare soil up until mid-June to late June (depending on ADD) when it begins to show a vegetation signature. It then increases in vigor rapidly until it reaches tasseling (usually early to mid-July—again tied to ADD) and then tapers off until late July or early August (ADDs again). Most other natural vegetation has a more steady continuous growth curve, wheat peaks in vegetative vigor earlier in the year and soybeans later. By understanding the growth curve of corn and having it tied to ADD where corn is being grown, total acres planted can be predicted. Once corn acreage is delineated, the growth curves for these specific areas can be compared to previous years yield values. Weather data is used to calibrate the predictions more accurately and yield is then predicted for all corn acres. By combining yield with acreage, total corn production for an area can be predicted.

### Example 4

### Greenhouse Gas Emission Use and Prediction Model

One of the requirements for sustainability is the demonstration of reduced Greenhouse Gas (“GHG”) emission. The assessment of carbon stock in row crop agriculture is a condition that can be analyzed using the current invention. The carbon stock change (ie. carbon emissions or sequestration effects) is a variable used to assess the sustainability impact of a parcel conversion. This variable can also be used to predict the feedstock yield potential of a converted parcel under row crop agriculture.

What is claimed is:

1. A method for evaluating a parcel of land using a computer system, the method comprising:
selecting a land parcel of interest in a data layer;
recoding categories of data in the data layer;
creating a matrix identifying the categories within the data layer;
quantifying the categories contained within the matrix; and
displaying the quantified data in a display.

2. The method of claim 1, further comprising:
comparing a first data layer or dataset for the land parcel from a first time point to a second data layer or dataset for the land parcel from a second time point to generate a comparison;
generating a matrix from the comparison; and
determining the difference in land use from the matrix.

3. The method of claim 1 or 2, wherein roadway buffers are removed from the data layers.

4. The method of claim 1 or 2, wherein transition areas are removed from the data layers.

5. The method of claim 2, further comprising:
assessing whether a change in land use is a likely land use or unlikely land use change; and
removing any of the unlikely land use changes from the dataset.

6. The method of claims 5, further comprising:
highlighting a region of the likely land use change; and
visually displaying the region of the likely land use change.

7. The method of claim 1 or 2, further comprising linking the display of the region of the land use to a secondary data source to verify or refute the land use.

8. The method of claim 1, further comprising:
defining an area of interest within the parcel of land; and
creating a report regarding the defined area.

9. A method of claim 2, further comprising:
predicting in-season crop growth by comparing one or more conditions with historical data of the conditions within the data layer or dataset to predict in-season crop growth.

10. A method of claim 9, further comprising comparing the NDVI of a crop and ADD of the region where the crop is located to NDVI and ADD from one or more previous growing seasons.
